(19) United States
(12) Patent Application Publication
(10) Pub. No.: US 2025/0274346 A1
(43) Pub. Date: Aug. 28, 2025

(54) NETWORK SLICING FIXED WIRELESS ACCESS (FWA) USE CASE

(71) Applicant: TELEFONAKTIEBOLAGET LM ERICSSON (PUBL), Stockholm (SE)

(72) Inventors: Mohammed Ziauddin MUJALE, Athlone (IE); Gianluca QUAGLIOZZI, Rome (IT); Sergio Arense GOMEZ, Madrid (ES)

(21) Appl. No.: 18/858,851

(22) PCT Filed: Apr. 21, 2023
(86) PCT No.: PCT/EP2023/060541

§ 371 Date: Oct. 22, 2024

Related U.S. Application Data
(60) Provisional application No. 63/333,700, filed on Apr. 22, 2022.

(51) Int. Cl. H04L 41/0895; H04L 41/0806

(52) U.S. Cl. CPC H04L 41/0895; H04L 41/0806

(57) ABSTRACT

A method by a network node to allocate a network slice instance includes: receiving a request for a network slice instance, NSI, allocation, the request having network slice related requirements; determining whether to create a new NSI or use an existing NSI; responsive to determining to create a new NSI, deriving network slice subnet related requirements based on the network slice related requirements, wherein deriving the network slice subnet related requirements comprises determining a type of a slice service type, SST, the request is for; responsive to the type of the slice being a SST for fixed wireless access, FWA, obtaining a cell identifier list, CellIDList, of cells where the NSSI is to be created; executing an allocate network slice subnet instance, NSSI, procedure based on the CellIDList; associating the NSSI with the NSI; and transmitting an allocate NSI response to a network slice management service consumer, NSMS_consumer.

### TECHNICAL FIELD

The present disclosure relates generally to communications, and more particularly to communication methods and related devices and nodes supporting wireless communications.

### BACKGROUND

A network slice is a logical network serving a defined business purpose or customer. Network slices consists of multiple slice subnets which in turn consist of all required network resources configured together.

Network slicing orchestration requires a standard way of describing the life cycle management of the network slices. Since network slices will be created for various different segments of the industries, the business use cases are bound to be very different. To generalize these procedures to support a variety of use cases, it is necessary that they are flexible and extendable. Network slice orchestration procedures are part of the operations support system (OSS). Network slice orchestration is the way to create, e.g., the 5G Network Slices and manage its life cycle.

The 3rd Generation Partnership Project (3GPP) drives the standardization of network slice life cycle management. The direction of standardization needs to ensure that the network slices can be managed and used for different business cases across industries. Network slice orchestration standards are described in 3GPP Technical Specifications, mainly technical specification (TS) 28.531 and TS 28.541. The classification of slice types is defined in 3GPP TS 23.501.

There currently exist certain challenge(s). As the standards are evolving, there are certain gaps that need to be addressed. Fixed Wireless Access (FWA) is one such use case in a gap that needs to be addressed. FWA requires the location to be considered fixed and provision the radio access network (RAN) resources only in those fixed area or cells. As of today, based on the specifications this is not possible, rather the slices get created all across Tracking Areas (TAs). The work around can be to have small TAs, but this has negative consequences of increased signaling load on the network which operators generally do not like and generally would like to avoid.

### SUMMARY

For provisioning of slices, 3GPP has defined a TAList at the NSSMF (network slice subnet management function) level as input parameter in the RANSliceSubnetProfile. The slices that are created on all the cells in the TAList and the resources need to be allocated. This is not efficient for the FWA use case, where only a subset of cells needs to be allocated for the slice with the resources. While the FWA slice is created across the TAList (or a TA), resources need to be allocated only in a subset of cells.

Similarly, on the Core network side, for devices connected to the FWA slices, the mobility aspects can be exempted. This results in slices being simpler and lighter in terms of signaling data.

Certain aspects of the disclosure and their embodiments may provide solutions to these or other challenges. The FWA use case, requires the provisioning procedures defined in 3GPP TS 28.531 to consider a subset of TA or TAs to be provisioned with resources to be allocated for the spectrum share. This will prevent the orchestration systems from allocating the resources across the complete list of TAs provided for FWA, which is not the requirement for FWA.

To identify the requested slice is of type FWA, the slice/service type (SST) value for slices of type FWA can be fixed by 3GPP. The SST value can be the next available number or any number not being used. The next available number is number 6.

For the FWA slice type, the service profile at the NSMF (network slice management function) will have to contain the coverage area and subArea to which the resources have to be allocated. An additional parameter is required in the profiles to provide the orchestration system the input required.

For NSSMF, provisioning of a RAN Slice subnet needs to contain the list of cells to which the resources will be allocated need to be provided as input. Hence the RANSliceSubnet profile will have to support a new parameter which will be called the CellIDList.

The combination of the SST and the parameters in the profiles will enable the required orchestration to create the slices for FWA in an efficient way.

According to some embodiments, a method by a network node to allocate a network slice instance includes receiving a request for a network slice instance, NSI, allocation, the request having network slice related requirements. The method includes determining whether to create a new NSI or use an existing NSJ. The method includes responsive to determining to create a new NSI, deriving network slice subnet related requirements based on the network slice related requirements, wherein deriving the network slice subnet related requirements comprises determining a type of a slice service type, SST, the request is for. The method includes responsive to the type of the slice being a SST for fixed wireless access, FWA, obtaining a cell identifier list, CellIDList, of cells where the NSSI is to be created. The method includes allocating a network slice subnet instance, NSSI, based on the CellIDList; associating the NSSI with the NSI. The method includes transmitting an allocate NSI response to a network slice management service consumer, NSMS_consumer.

According to other embodiments, a method by a network node to allocate a network slice subnet instance includes receiving a request for a network slice subnet instance, NSSI, allocation, the request having network slice subnet related requirements. The method includes determining whether to use an existing NSSI or create a new NSSI based on the network slice subnet related requirements and existing NSSI capabilities. The method includes responsive to determining to create the new NSSI, deriving network slice subnet constituent related requirements based on the network slice subnet related requirements, wherein deriving the network slice subnet constituent related requirements comprises checking for a slice service type, SST, for a fixed wireless access, FWA. The method includes responsive to the SST being for a FWA, executing a procedure based on the network slice subnet related requirements. The method includes completing an allocation procedure to complete a network slice subnet instance allocation. The method includes transmitting an allocate NSSI response to a network slice subnet management service consumer, NSSMS_consumer.

Analogous network nodes, computer programs, and computer program products to the above embodiments are provided.

Certain embodiments may provide one or more of the following technical advantage(s). As FWA use cases are fixed to locations, the resource allocation is very important as it has to be efficiently used, primarily in RAN. Hence it will optimize the resource usage by provisioning the resource based on the requirement provided.

This approach can also consider using the FWA SST value to mark the devices as fixed and reduce the complexity of mobility feature tracking on the Core Network.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signaling diagram of a current network slice allocation request procedure;

FIG. 2 is a flowchart illustrating checking for SST type according to some embodiments;

FIGS. 3-4 are flowcharts illustrating operations of a network node according to some embodiments;

FIGS. 5A and 5B are a signaling diagram of a current network slice subnet instance allocation request procedure;

FIG. 6 is a flowchart illustrating checking to determine the type of slice according to some embodiments;

FIG. 7 is a flow chart illustrating operations of a network node according to some embodiments of inventive concepts;

FIG. 8 is a block diagram of a communication system in accordance with some embodiments;

FIG. 9 is a block diagram of a user equipment in accordance with some embodiments;

FIG. 10 is a block diagram of a network node in accordance with some embodiments;

FIG. 11 is a block diagram of a host computer communicating with a user equipment in accordance with some embodiments;

FIG. 12 is a block diagram of a virtualization environment in accordance with some embodiments; and

FIG. 13 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, fixed wireless access (FWA) requires the location to be considered fixed and provision the RAN resources only in those fixed areas or cells. As of today, based on the 3GPP specifications, this is not possible. Instead, the slices get created all across Tracking Areas (TAs). The work around can be to have small TAs, but this has negative consequences of increased signaling load on the network which operators generally do not like it.

There are different types of network slices that can be created. The 3GPP has defined a few standard slice types as indicated in the table below. It is possible to define up to 255 different slice types.

| Slice/ | SST | |
|---|---|---|
| Service type | value | Characteristics |
| eMBB | 1 | Slice suitable for the handling of 5G enhanced |
| | | Mobile Broadband. |
| URLLC | 2 | Slice suitable for the handling of ultra- reliable low |
| | | latency communications. |
| MIoT | 3 | Slice suitable for the handling of massive IoT. |
| V2X | 4 | Slice suitable for the handling of V2X services. |
| HMTC | 5 | Slice suitable for the handling of High-Performance |
| | | Machine-Type Communications. |

Fixed Wireless Access has unique networking requirements. Since the device locations are fixed, the resources allocated in the radio access network (RAN) can be only on those cells to which the device gets connected. There is no necessity to allocate the spectrum resources across all the cells in the TA. Also, since the devices are not in motion, the mobility requirements are void for this use case.

Hence it is required for the network as well as the management system to know about the type of slice the devices are connected to. FWA needs to be considered as another standard slice type and be allocated a Standardized SST value to it. In the description that follows, it is assumed that FWA has been assigned the next available SST value, which is 6. This is illustrated in the table below:

| Slice/ | SST | |
|---|---|---|
| Service type | value | Characteristics |
| FWA | 6 | Slice suitable for the FWA devices with no mobility |
| | | requirements. |

The Provisioning Management services of NSMF and NSSMF can consider the SST value and take necessary actions in their respective procedures to determine the resources to be allocated.

A service profile “SubArea” attribute will need to be added to provide information where the spectrum needs to be allocated. The SubArea attribute can be considered optional as it will only be needed when the slice is oftype FWA.

The characteristics ofthe SubArea attribute is shown below:
Attribute name=SubArea
S=O
isReadable=T
isWritable=T
islnvariant=F
isNotifyable=T

| Attribute name | S | isReadable | isWritable | isInvariant | isNotifyable |
|---|---|---|---|---|---|
| serviceProfileId | M | T | F | T | T |
| pLMNInfoList | M | T | F | F | T |
| maxNumberofUEs | O | T | T | F | T |
| coverageArea | O | T | T | F | T |
| SubArea | O | T | T | F | T |
| dLLatency | O | T | T | F | T |
| uLLatency | O | T | T | F | T |
| uEMobilityLevel | O | T | T | F | T |
| networkSliceSharingIndicator | O | T | T | F | T |
| sST | M | T | T | F | T |
| availability | O | T | T | F | T |
| delayTolerance | O | T | T | F | T |
| dLDeterministicComm | O | T | T | F | T |
| uLDeterministicComm | O | T | T | F | T |
| dLThptPerSlice | O | T | T | F | T |
| dLThptPerUE | O | T | T | F | T |
| uLThptPerSlice | O | T | T | F | T |
| uLThptPerUE | O | T | T | F | T |
| dLMaxPktSize | O | T | T | F | T |
| uLMaxPktSize | O | T | T | F | T |
| maxNumberofPDUSessions | O | T | T | F | T |
| kPIMonitoring | O | T | T | F | T |
| userMgmtOpen | O | T | T | F | T |
| v2XCommModels | O | T | T | F | T |
| termDensity | O | T | T | F | T |
| activityFactor | O | T | T | F | T |
| uESpeed | O | T | T | F | T |
| jitter | O | T | T | F | T |
| survivalTime | O | T | T | F | T |
| radioSpectrum | O | T | T | F | T |
| reliability | O | T | T | F | T |
| maxDLDataVolume | O | T | T | F | T |
| maxULDataVolume | O | T | T | F | T |
| nBIoT | O | T | T | F | T |
| synchronicity | O | T | T | F | T |
| positioning | O | T | T | F | T |
| sliceSimultaneousUse | O | T | T | F | T |
| energyEfficiency | O | T | T | F | T |
| nssaaSupport | O | T | T | F | T |
| n6Protection | O | T | T | F | T |

Similarly, in the RAN Slice Subnet profile, “CellIDList” needs to be added to indicate the cells where the spectrum allocation or resources are required. The characteristics of the CellIDList are shown below:
Attribute name=cellTDList
S=O
isReadable=T
isWritable=T
isnvalant=F
isNotifyable=T

| | | isRead- | isWrit- | isIn- | isNoti- |
|---|---|---|---|---|---|
| Attribute name | S | able | able | variant | fyable |
| coverageAreaTAList | O | T | T | F | T |
| cellIDList | O | T | T | F | T |
| uEMobilityLevel | O | T | T | F | T |
| resourceSharingLevel | O | T | T | F | T |
| maxNumberofUEs | O | T | T | F | T |
| activityFactor | O | T | T | F | T |
| dLThptPerSliceSubnet | O | T | T | F | T |
| dLThptPerUE | O | T | T | F | T |
| uLThptPerSliceSubnet | O | T | T | F | T |
| uLThptPerUE | O | T | T | F | T |
| uESpeed | O | T | T | F | T |
| reliability | O | T | T | F | T |
| nROperatingBands | O | T | T | F | T |
| serviceType | O | T | T | F | T |
| dLLatency | O | T | T | F | T |
| uLLatency | O | T | T | F | T |
| delayTolerance | O | T | T | F | T |
| sliceSimultaneousUse | O | T | T | F | T |
| dLMaxPktSize | O | T | T | F | T |
| uLMaxPktSize | O | T | T | F | T |
| energyEfficiency | O | T | T | F | T |
| termDensity | O | T | T | F | T |
| survivalTime | O | T | T | F | T |
| dLDeterministicComm | O | T | T | F | T |
| uLDeterministicComm | O | T | T | F | T |
| positioning | O | T | T | F | T |
| synchronicity | O | T | T | F | T |

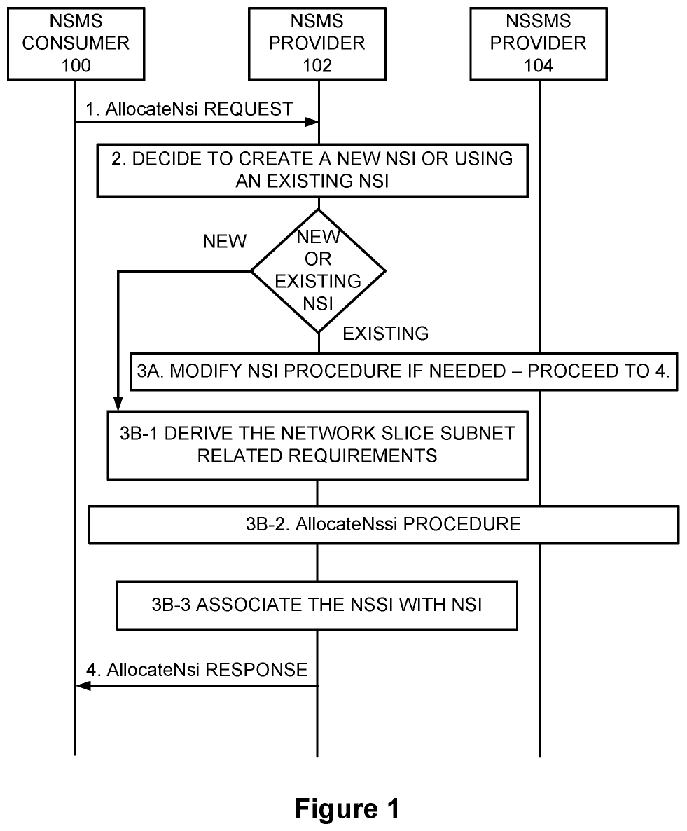

FIG. 1 illustrates a NSMF provisioning procedure. The existing procedure is as follows:

Operation 1.) The Network Slice Management Service Provider (NSMS_Provider) 102 receives an AllocateNsi request (see AllocateNsi operation defined in clause 6.5.1 of 3GPP TS 28.531 for further details) from the Network Slice Management Service Consumer (NSMS_Consumer) 100 with network slice related requirements (the network slice related requirements are defined as the attributes in the ServiceProfile—see clause 6.3.3 in 3GPP TS 28.541).

Operation 2) Based on the network slice related requirement and the knowledge of the capabilities of existing deployed network slices, the NSMS_Provider 102 compares/matches the provided requirements against all the candidate NetworkSlice instances, and then decides whether to use an existing NSI (network slice instance) or create a new NSI. If the network slice related requirements allow the requested NSI to be shared and if an existing suitable NSI can be reused, the NSMS_Provider 102 may decide to use the existing NSI.

Operation 3a) If using an existing NSI and the existing NSI needs to be modified to satisfy the network slice related requirements, the NSMS_Provider 102 invokes the procedure to modify the existing NSI as described in clause 7.6 of 3GPP TS 28.531.

Operation 3b-1) If creating a new NSI, the NSMS_Provider 102 derives the network slice subnet related requirements from the received network slice related requirements. Before the NSMS_Provider 102 derives the network slice subnet related requirements, the NSMS_Provider 102 may invoke corresponding network slice subnet capability information querying procedure as described in clause 7.8 of 3GPP TS 28.531.

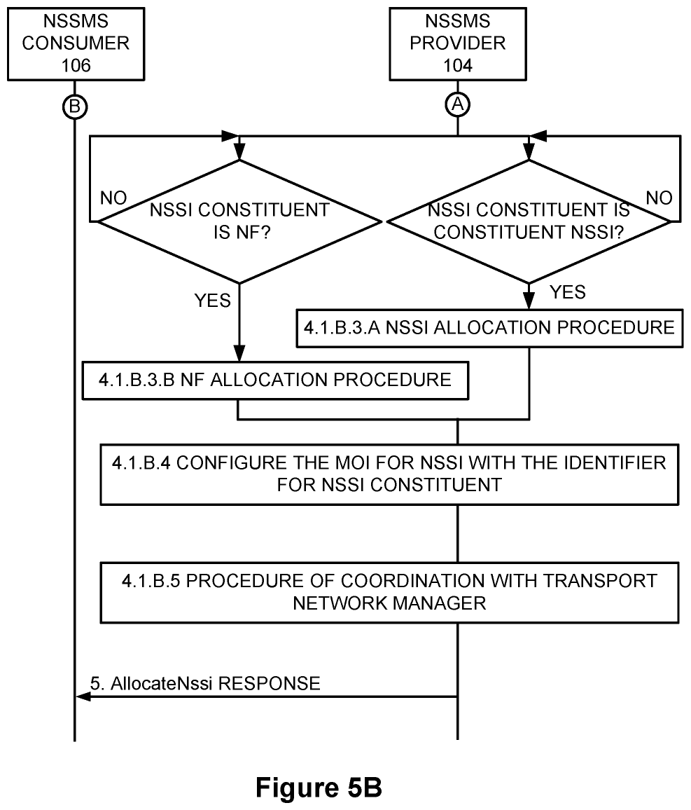

Operation 3b-2) The NSMS_Provider 102 invokes the NSSI allocation procedure as described below (see FIGS. 5A and 5B) and in clause 7.3 of 3GPP TS 28.531.

Operation 3b-3) The NSMS_Provider 102 creates the MOI (managed object instance) for NetworkSlice and configures the MOI with the DN (data network) of the MOI for the NetworkSliceSubnet. Other configuration information may be configured for the created MOI.

NOTE: The detailed configuration information is described in network slice network resource model (NRM) (see NetworkSlice IOC (information object class) defined in clause 6.3.1 in 3GPP TS 28.541).

Operation 4) The NSMS_Provider 102 sends the NSI allocation result (see AllocateNsi operation defined in clause 6.5.1 of 3GPP TS 28.531) to the NSMS_Consumer 100. If an existing NSI is modified or a new NSI is created successfully to satisfy the network slice related requirements, the result includes the relevant network slice instance information (see NetworkSlice IOC defined in clause 6.3.1 in TS 28.541):
DN of the NetworkSlice.

Otherwise, the result may include the reason of failure, for example, the required latency or user number cannot be satisfied, or the physical resource is not enough.

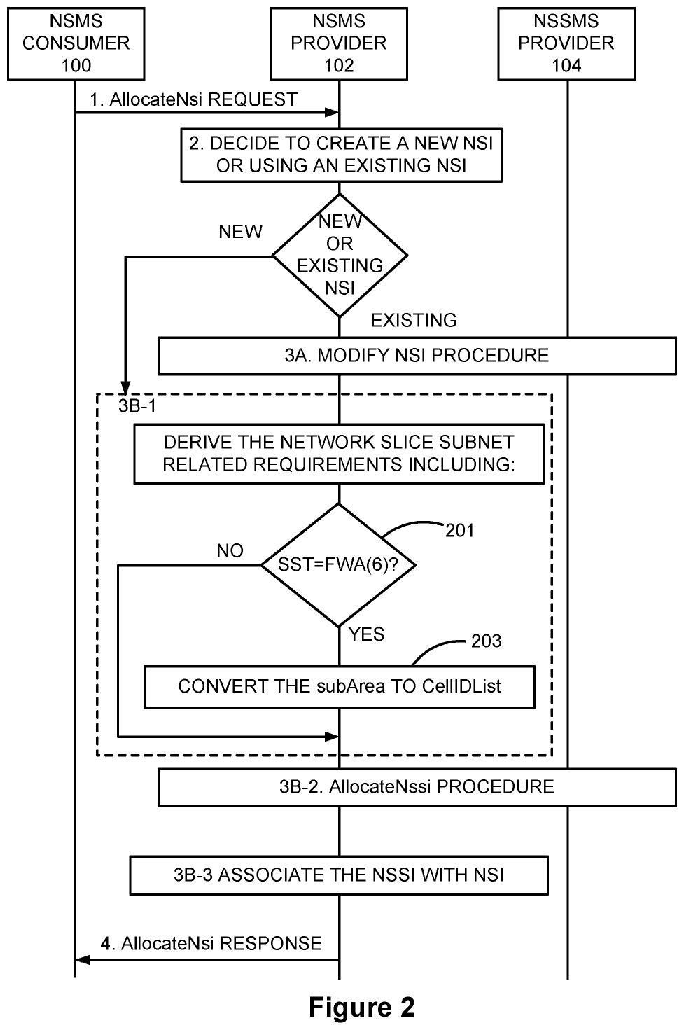

The existing network slice instance allocation procedure (AllocateNsi) as defined in 3GPP TS 28.531 and described above with respect to FIG. 1 will have to include a check for SST type and take necessary actions. FIG. 2 illustrates an embodiment of checking for SST type and an action that can be taken.

Turning to FIG. 2, the existing network slice instance allocation procedure of operations 1-2 are performed and when the decision to create a new NSI is made, operation 3B-1 is performed. As part of operation 3B-1, operation 201 is performed where the NSMS_Provider 102 determines if the SST is for a fixed wireless access. This determination can be based on determining if the SST value is the value for FWA (e.g., an SST value of 6). When the SST is for a FWA, operation 203 is performed where the subArea attribute is converted to a CellIDList. Thus, the subArea is translated into a list of cells where the network slice needs to be created.

The remainder of the NSI allocation procedure is continued to complete the network slice creation as described above in FIG. 1.

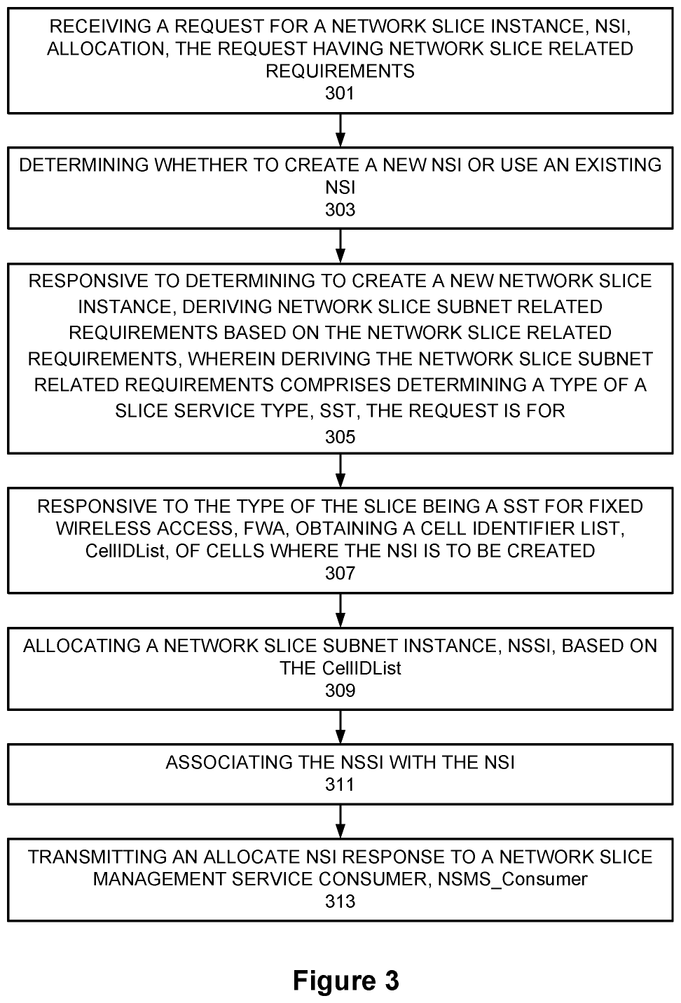

FIG. 3 illustrates operations from the perspective of a network node to allocate a network slice. Thus, the network node is configured to perform operations of a network slice management service provider 102.

The network node may be any of network nodes 810A, 810B, 1000, 1202, and 1304. In the description that follows, operations of the network node shall be described using network node 1000 (implemented using the structure of FIG. 10). For example, modules may be stored in memory 1004 of FIG. 10, and these modules may provide instructions so that when the instructions of a module are executed by respective network node processing circuitry 1002, network node 1000 performs respective operations of the flow chart.

Turning to FIG. 3, in block 301, the network node 1000 receives a request for a network slice instance (NSI) allocation, the request have network slice related requirements. In some embodiments, the network node 1000 receives the request for the NSI allocation from a network slice management service consumer, NSMS_consumer 100. In other embodiments, the network node 1000 can receive the request from other entities such as, for example, an agent on behalf of the NSMS_consumer 100 or from other entities. The network node determines whether to create a new NSI or using an existing NSI. As explained above, the determination can be based on the network slice related requirements and the knowledge of the capabilities of existing deployed network slices.

In block 305, responsive to determining to create a new network slice instance, the network node 1000 derives network slice subnet related requirements based on the network slice related requirements, wherein deriving the network slice subnet related requirements includes determining a type of a slice service type, SST, the request is for. In some embodiments, the network node 1000 determines the type of slice based on the SST value by determining the type of slice is a fixed wireless access slice based on the SST value being a service type value allocated to the fixed wireless access slice/service type.

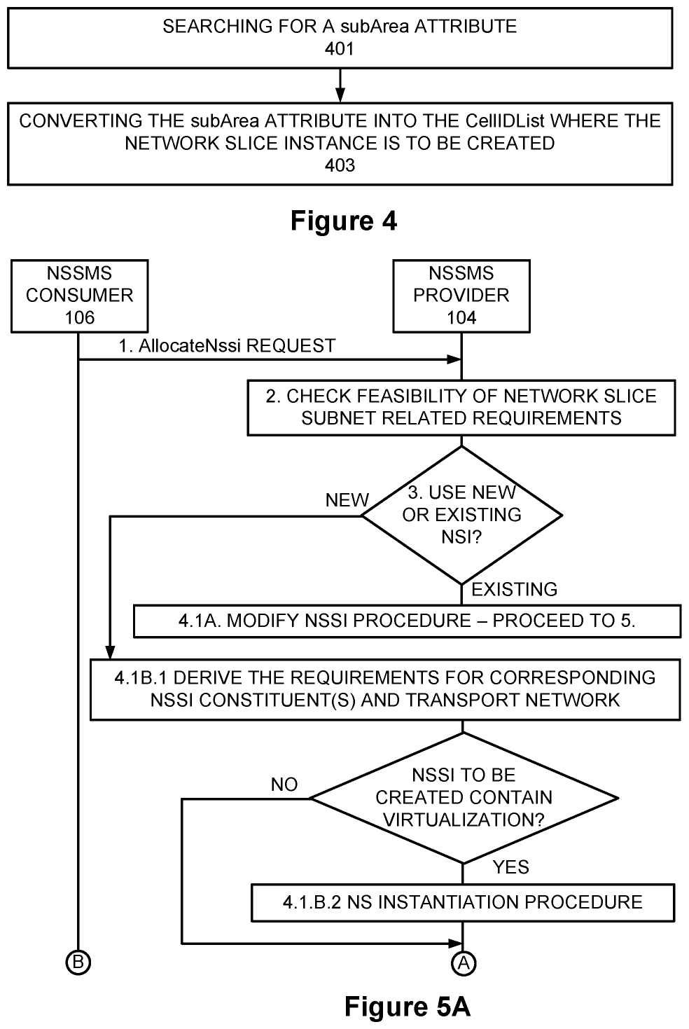

Responsive to the type of the slice being a SST for fixed wireless access, FWA, the network node 1000 in block 307 obtains a cell identifier list, CellIDList, of cells where the NSSI is to be created. FIG. 4 illustrates an embodiment of obtaining the CellIDList.

Turning to FIG. 4, in block 401, the network node 1000 searches for a subArea attribute as described above. In block 402, the network node 1000 converts the subArea attribute into the CellIDList where the network slice instance is to be created. The subArea attribute and the CellIDList has characteristics as previously described.

Returning to FIG. 3, in block 309, the network node 1000 allocates a network slice subnet instance (NSSI) based on the CellIDList. In block 311, the network node 1000 associates the NSSI with the NSI. In block 313, the network node 1000 transmits an allocate NSI response to a network slice management service consumer, NSMS_consumer 100.

FIGS. 5A and 5B illustrate a NSSMF (network slice subnet management function) provisioning procedure. The existing procedure is as follows:

Operation 1): The Network Slice Subnet Management Service Provider (NSSMS_Provider) 104 receives an AllocateNssi request (see AllocateNssi operation defined in clause 6.5.2 of 3GPP TS 28.531) from a Network Slice Subnet Management Service Consumer (NSSMS_Consumer) 500 with network slice subnet related requirements (network slice subnet related requirements defined in SliceProfile—see clause 6.3.4 of 3GPP TS 28.541.

Operation 2) The NSSMS_Provider 104 checks the feasibility of the network slice subnet related requirements. If the network slice subnet related requirements can be satisfied, operation 3) is needed, else go to operation 5).

Operation 3) Based on the network slice subnet related requirements and the existing NSSI capabilities, the NSSMS_Provider 104 decides whether to use an existing NSSI or create a new NSSI. If the network slice subnet related requirements allow the requested NSSI to be shared and if an existing suitable NSSI can be reused, the NSSMS_Provider 104 decides to use the existing NSSI.

Operation 4.1a) If using an existing NSSI and the existing NSSI needs to be modified to satisfy the network slice subnet related requirements, the NSSMS_Provider 104 invokes the procedure to modify the existing NSSI as described in clause 7.7 of 3GPP TS 28.531.

Operation 4.1b.1) If creating a new NSSI, the NSSMS_Provider 104 creates the NetworkSliceSubnet MOI (management object instance). The NSSMS_Provider 104 derives the corresponding network slice subnet constituent (i.e., NF (network function), constituent NSS (network slice subnet)) related requirements and transport network related requirements (e.g., 3GPP endpoint information, latency requirements, bandwidth requirements and isolation requirements) from the received network slice subnet related requirements. Part of these requirements may be referenced by attribute “epTransportRef” as defined in clause 6.3.2.2 in TS 28.541. Before the NSSMS_Provider 104 derives the constituent network slice subnet related requirements, the NSMS_Provider may invoke corresponding network slice subnet capability information querying procedure as described in clause 7.8.2 of 3GPP TS 28.531.

Operation 4.1b.2) If the NSSI to be created contains a virtualization part (i.e., VNF (virtualized network function) or VL (virtual link)), the NSSMS_Provider 104 derives the NS instance instantiation information (the NS instance instantiation information is described in clause 7.3.2.2 and clause 7.3.3.2 of ETSI GS NFV-IFA 013) based on network slice subnet related requirements. The NSSMS_Provider 104 determines new VNF instance(s) that need to be deployed and the existing VNF instance(s) that need to be reused according to the necessary network function(s) and then derives the profile of virtual link(s) according to the connection requirements between the network functions. The NSSMS_Provider 104 chooses a proper NSD (network service descriptor) deployment flavour and creates data concerning the SAPs of the NS instance. The NSSMS_Provider invokes the NS instantiation procedures to create a NS instance. The NSSMS_Provider 104 configures the NSS MOI with the NS instance identifier.

NOTE: The NS instantiation procedure is described in 3GPP TS 28.526.

Operation 4.1b.3) For each required NSSI constituent, the following step 4.1b.3a) and 4.1b.3b) are needed:

Operation 4.1b.3a) If the required NSSI constituent is constituent NSSI, the NSSMS_Provider 104 invokes an NSSI Allocation Procedure.

Operation 4.1b.3b) If the required NSSI constituent is NF instance, the NSSMS_Provider 104 invokes NF Creation Procedure as described in clause 7.10 of 3GPP TS 28.531 or NF Modification Procedure as described in clause 7.11 of 3GPP TS 28.531.

Operation 4.1b.4) The NSSMS_Provider 104 configures the NetworkSliceSubnet MOI with the DN of the MOI for NSSI constituent (i.e., ManagedFunction MOI, NetworkSliceSubnet MOI).

Operation 4.1b.5) For each required transport network related requirements, the NSSMS_Provider 104 invokes corresponding procedure of coordination with relevant transport network (TN) Manager to handle the TN part as described in clause 7.9 of 3GPP TS 28.531.

Operation 5) The NSSMS_Provider 104 sends the NSSI allocation result (see AllocateNssi operation defined in clause 6.5.2 3GPP TS 28.531) to the NSSMS_Consumer 500. If the NSSI is created successfully, the result includes the relevant constituent network slice subnet instance information (see NetworkSliceSubnet IOC defined in clause 6.3.2 in TS 28.541):
DN of the NetworkSliceSubnet MOI.
NS instance Info (e.g., NSinstanceId)

Otherwise, the result may include the reason of failure, for example, the required latency or user Number cannot be satisfied, or the physical resource is not enough.

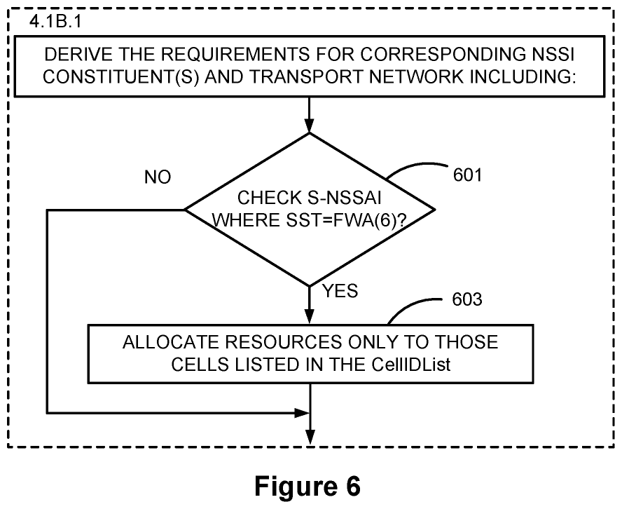

The existing AllocateNssi procedure in the 3GPP TS 28.531 specification, as described above in FIGS. 5A and 5B, requires modification with additional processing to check the S-NSSAI (single-network slice selection assistance information) for SST to determine if the SST is for FWA. When the SST is for FWA, the procedure will take necessary actions on the list of cells that were provided as inputs. FIG. 6 illustrates an embodiment of checking for SST type and action(s) that can be taken on the list of cells in the CellIDList.

Turning to FIG. 6, when the network node 1000 performs operation 4.1B.1, the network node also checks, in block 601, the S-NSSAI to determine if the SST is for FWA (e.g., an SST value of 6). If the SST is for FWA, the network node 1000 allocates resources only to those cells listed in the CellIDList. The CellIDList is identified by the NSMF provisioning procedure described above in FIGS. 2-4.

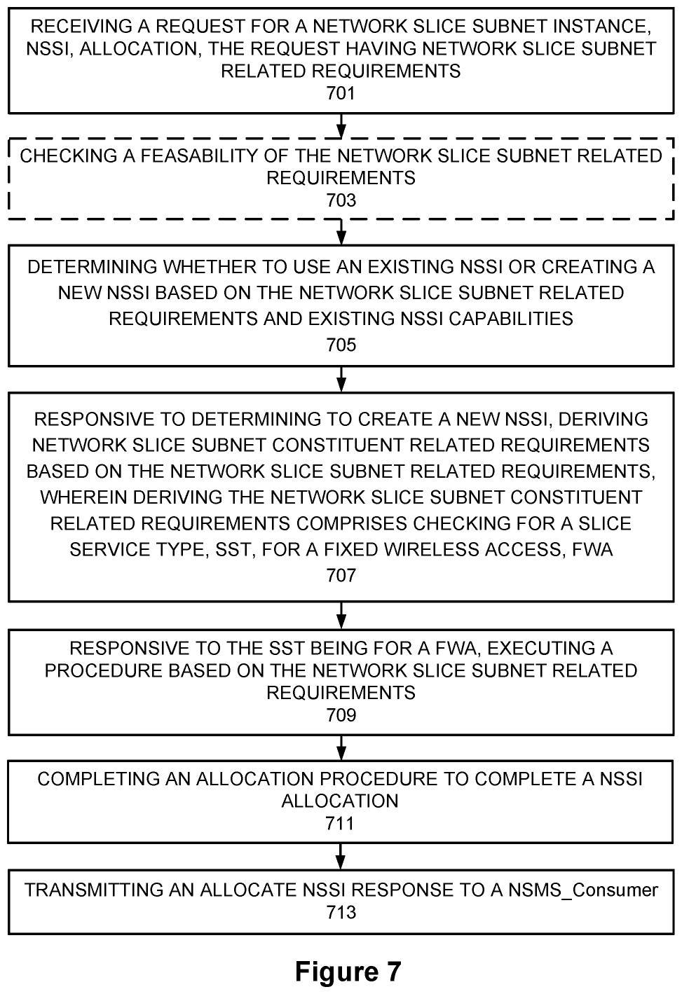

FIG. 7 illustrates operations from the perspective of a network node to allocate a network slice subnet instance. Thus, the network node is configured to perform operations of a network slice subnet management service provider 104.

Turning to FIG. 7, in block 701, the network node 1000 receives a request for a network slice subnet instance, NSSI, allocation, the request having network slice subnet related requirements. In some embodiments, the network node 1000 receives the request for the NSSI allocation from a network slice subnet management service consumer, NSSMS_consumer 500. In other embodiments, the network node 1000 can receive the request from other entities such as, for example, an agent on behalf of the NSSMS_consumer 500 or from other entities.

In block 703, the network node checks a feasibility of the network slice subnet related requirements. The operations of block 703 are analogous to the operations described above in operation 2 of FIG. 5A and are optional in some embodiments.

In block 705, the network node 1000, determines whether to use an existing NSSI or create a new NSSI based on the network slice subnet related requirements and existing NSSI capabilities. Further details are described above in operation 3 of FIG. 5A. In some embodiments the network node 1000 determines whether to use the existing NSSI or create a new NSSI responsive to the network slice subnet related requirements can be satisfied.

In block 707, the network node 1000, responsive to determining to create the new NSSI, derives network slice subnet constituent related requirements based on the network slice subnet related requirements, wherein deriving the network slice subnet constituent related requirements comprises checking for a slice service type, SST, for a fixed wireless access, FWA.

In block 709, the network node 1000, responsive to the SST being for a FWA, executes a procedure based on the network slice subnet related requirements. In some embodiments, the network node 1000 executes the procedure by provisioning only cells that were identified by a network slice instance allocation procedure. As described above, the cells that were identified by a network slice instance allocation procedure are cells listed in the cell identifier list, CellIDList.

In block 711, the network node completes an allocation procedure to complete a network slice subnet instance allocation. In some embodiments, the remainder includes operations below operation 4.1B.1 in FIGS. 5A and 5B.

In block 713, the network node 1100 transmits an allocate NSSI response to a network slice management service consumer, NSSMS_consumer 500.

As described above, a new SST value (6 or a new number) for identification of FWA Slice type is required. For orchestration to know which location the FWA slice has to be created, subarea and CellIDList are added to the Service and the slice profiles respectively.

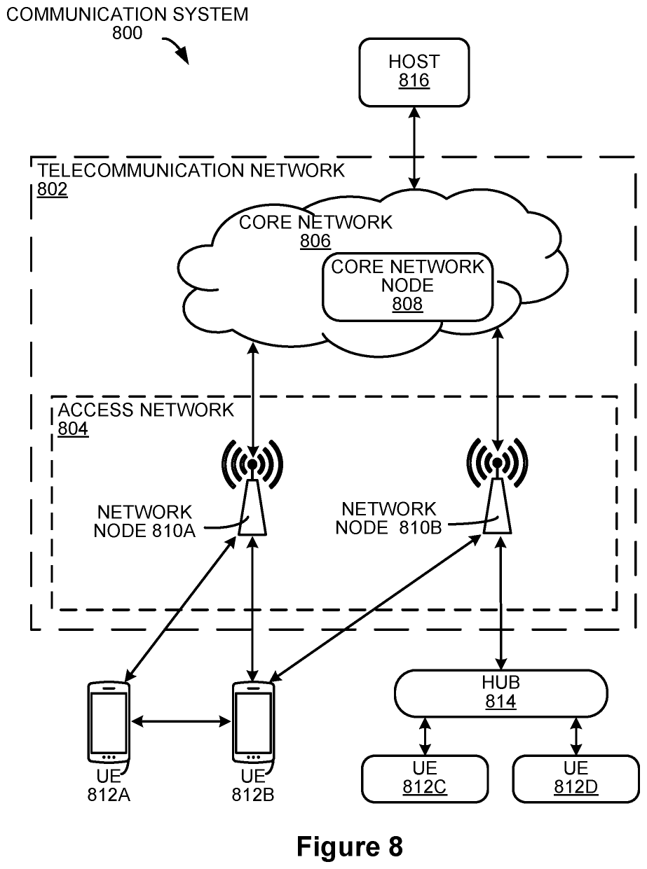

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810A and 810B (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi (Light Fidelity), and/or any low-power wide-area network (LPWAN) standards such as LoRa (Long Range) and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT (Internet of Things) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and network node 810B, but which is additionally capable of operating as a communication start and/or end point for certain data channels.

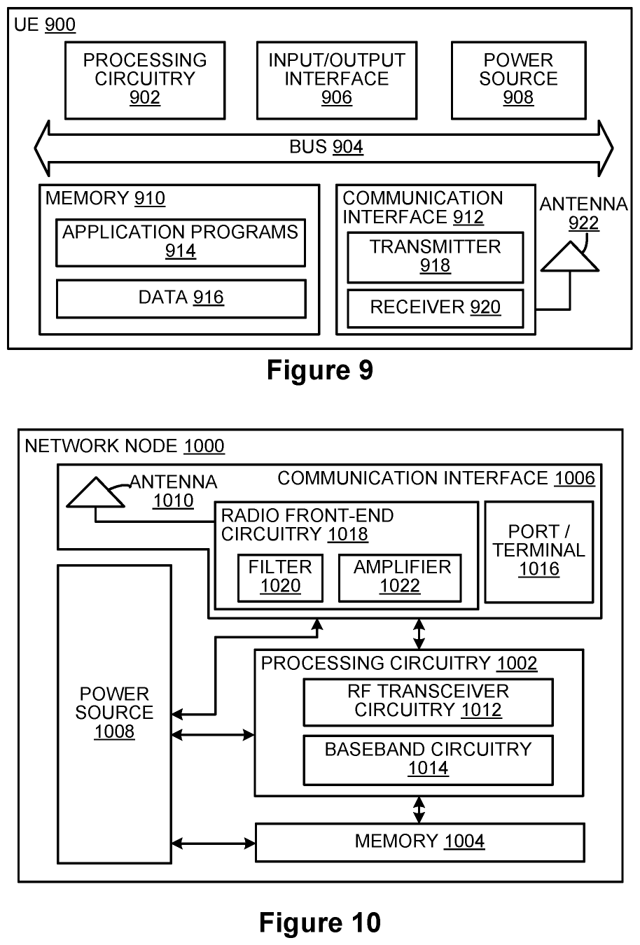

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

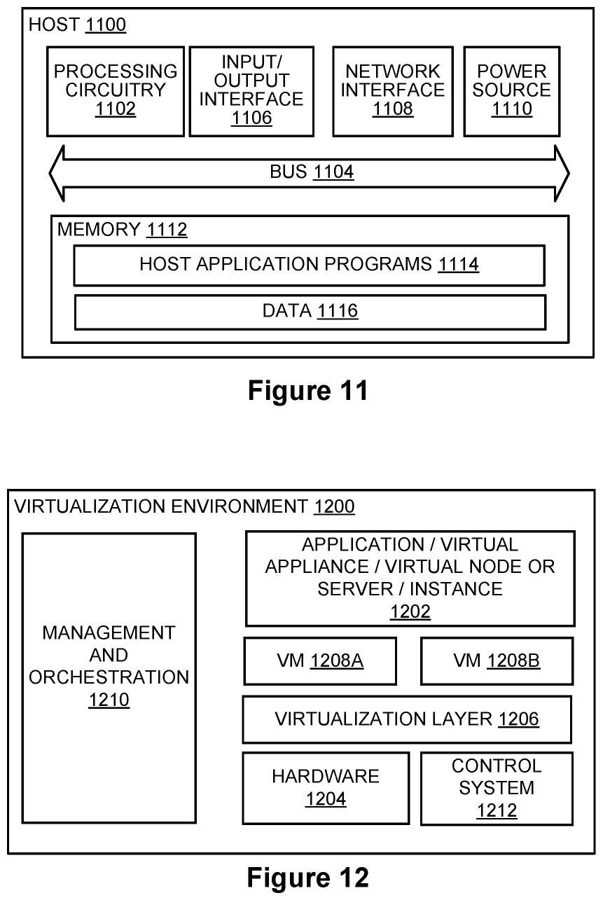

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208A and 1208B (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

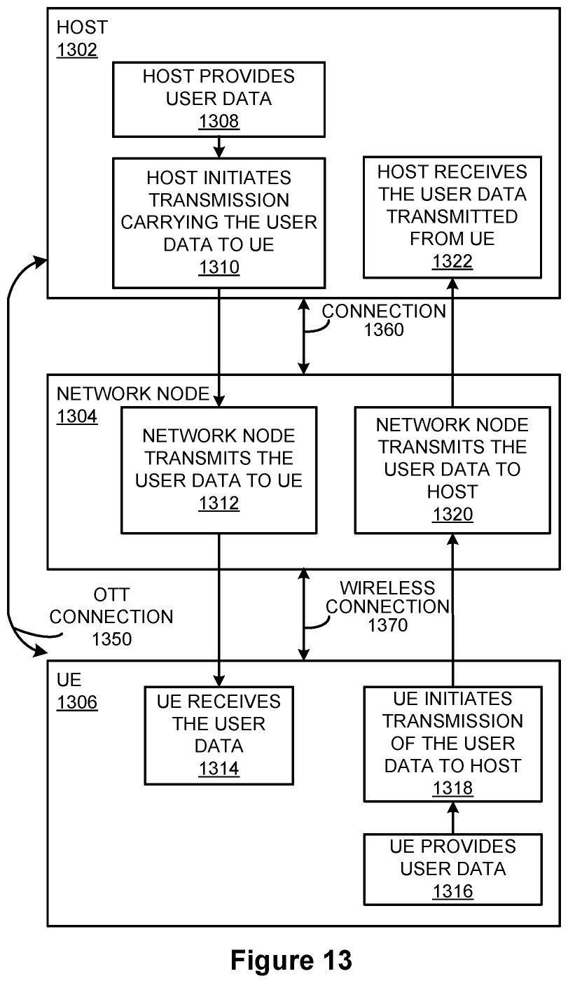

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812A of FIG. 8 and/or UE 900 of FIG. 9), network node (such as network node 810A of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### Enumerated Embodiments

1. A method by a network node (810A, 810B, 1000, 1202, 1304) to allocate a network slice instance, the method comprising:
receiving (301) a request for a network slice instance, NSI, allocation, the request having network slice related requirements;
determining (303) whether to create a new NSI or use an existing NSI;
responsive to determining to create a new network slice instance, deriving (305) network slice subnet related requirements based on the network slice related requirements, wherein deriving the network slice subnet related requirements comprises determining a type of a slice service type, SST, the request is for;
responsive to the type of the slice being a SST for fixed wireless access, FWA, obtaining (307) a cell identifier list, CellIDList, of cells where the NSSI is to be created;
allocating (309) a network slice subnet instance, NSSI, procedure based on the CellIDList;
associating (311) the NSSI with the NSI; and
transmitting (313) an allocate NSI response to a network slice management service consumer, NSMS_consumer (100).
   2. The method of Embodiment 1 wherein obtaining the CellIDList comprises:
searching (401) for a subArea attribute; and
converting (403) the subArea attribute into the CellIDList where the network slice instance is to be created.
   3. The method of Embodiment 2 wherein the subArea attribute has characteristics comprising:
Attribute name=SubArea
S=O
isReadable=T
isWritable=T
isInvariant=F; and
isNotifyable=T.
   4. The method of any of Embodiments 2-3, wherein the CellIDList has characteristics comprising:
Attribute name=CellIDList
S=O
isReadable=T
isWritable=T
isInvariant=F; and
isNotifyable=T.
   5. The method of any of Embodiments 1-4, further comprising determining the type of slice based on an SST value.
   6. The method of Embodiment 5, wherein determining the type of slice based on the SST value comprises determining the type of slice is a fixed wireless access slice based on the SST value being a service type value allocated to the fixed wireless access slice/service type.
   7. The method of any of Embodiments 1-6 wherein receiving the request for the NSI allocation comprises receiving the request for the NSI allocation from an NSMS_consumer (100).
   8. The method of any of Embodiments 1-7, wherein the network node performs operations of a network slice management service provider (102).
   9. A method by a network node (810A, 810B, 1000, 1202, 1304) to allocate a network slice subnet instance, the method comprising:
receiving (701) a request for a network slice subnet instance, NSSI, allocation, the request having network slice subnet related requirements;
determining (705) whether to use an existing NSSI or create a new NSSI based on the network slice subnet related requirements and existing NSSI capabilities;
responsive to determining to create the new NSSI, deriving (707) network slice subnet constituent related requirements based on the network slice subnet related requirements, wherein deriving the network slice subnet constituent related requirements comprises checking for a slice service type, SST, for a fixed wireless access, FWA;
responsive to the SST being for a FWA, executing (709) a procedure based on the network slice subnet related requirements;
completing (711) a remainder of an allocation procedure to complete a network slice subnet instance allocation; and
transmitting (713) an allocate NSSI response to a network slice subnet management service consumer, NSSMS_consumer (106).
   10. The method of Embodiment 9 wherein executing the procedure comprises provisioning only cells that were identified by a network slice instance allocation procedure.
   11. The method of Embodiment 10 wherein the cells that were identified comprises cells in a cell identifier list, CellIDList.
   12. The method of any of Embodiments 9-11, wherein the network node is configured to perform operations of a network slice subnet management service provider (104).
   13. The method of any of Embodiments 9-12, wherein receiving the request for the NSSI allocation comprises receiving the request for the NSSI allocation from an NSSMS_consumer (106).
   14. A network node (810A, 810B, 1000, 1202, 1304) comprising:
processing circuitry (1002); and memory (1004) coupled with the processing circuitry, wherein the memory includes
instructions that when executed by the processing circuitry causes the network node to perform operations according to any of Embodiments 1-13.
   15. A network node (810A, 810B, 1000, 1202, 1304) adapted to perform according to any of Embodiments 1-13.
   16. A computer program comprising program code to be executed by processing circuitry (1002) of a network node (810A, 810B, 1000, 1202, 1304), whereby execution of the program code causes the network node (810A, 810B, 1000, 1202, 1304) to perform operations according to any of Embodiments 1-13.
   17. A computer program product comprising a non-transitory storage medium including program code to be executed by processing circuitry (1002) of a network node (810A, 810B, 1000, 1202, 1304), whereby execution of the program code causes the network node (810A, 810B, 1000, 1202, 1304) to perform operations according to any of Embodiments 1-13.

### REFERENCES

[1] 3GPP TS 28.531 v 17.3.0 (2022-03) 3rd Generation Partnership Project; Technical Specification Group Services and System Aspects; Management and Orchestration; Provisioning (Release 17)
[2] 3GPP TS 28.541 v 17.6.0 (2022-03) 3rd Generation Partnership Project; Technical Specification Group Services and System Aspects; Management and Orchestration; 5G Network Resource Model (NRM); Stage 2 and stage 3 (Release 17)
[3] 3GPP TS 23.501 v 17.4.0 (2022-03) 3rd Generation Partnership Project; Technical Specification Group Services and System Aspects; System Architecture for the 5G System (5GS); Stage 2 (Release 17)

1. A method by a network node to allocate a network slice instance, the method comprising:
receiving a request for a network slice instance (NSI) allocation, the request having network slice related requirements;
determining whether to create a new NSI or use an existing NSI;
responsive to determining to create a new network slice instance, deriving network slice subnet related requirements based on the network slice related requirements, wherein deriving the network slice subnet related requirements comprises determining a type of a slice service type (SST) the request is for;
responsive to the type of the slice being a SST for fixed wireless access (FWA), obtaining a cell identifier list (CellIDList) of cells where the NSSI is to be created;
allocating a network slice subnet instance (NSSI) procedure based on the CellIDList;
associating the NSSI with the NSI; and
transmitting an allocate NSI response to a network slice management service consumer (NSMS_consumer).

2. The method of claim 1 wherein obtaining the CellIDList comprises:
searching for a subArea attribute; and
converting the subArea attribute into the CellIDList where the network slice instance is to be created.

3. The method of claim 2 wherein the subArea attribute has characteristics comprising:
Attribute name=SubArea
S=O
isReadable=T
isWritable=T
isInvariant=F; and
isNotifyable=T.

4. The method of claim 2, wherein the CellIDList has characteristics comprising:
Attribute name=CellIDList
S=O
isReadable=T
isWritable=T
isInvariant=F; and
isNotifyable=T.

5. The method of claim 1, further comprising determining the type of slice based on an SST value.

6. The method of claim 5, wherein determining the type of slice based on the SST value comprises determining the type of slice is a fixed wireless access slice based on the SST value being a service type value allocated to the fixed wireless access slice/service type.

7. The method of claim 1 wherein receiving the request for the NSI allocation comprises receiving the request for the NSI allocation from an NSMS_consumer.

8. The method of claim 1, wherein the network node performs operations of a network slice management service provider.

9. A method by a network node to allocate a network slice subnet instance, the method comprising:
receiving a request for a network slice subnet instance (NSSI) allocation, the request having network slice subnet related requirements;
determining whether to use an existing NSSI or create a new NSSI based on the network slice subnet related requirements and existing NSSI capabilities;
responsive to determining to create the new NSSI, deriving network slice subnet constituent related requirements based on the network slice subnet related requirements, wherein deriving the network slice subnet constituent related requirements comprises checking for a slice service type (SST) for a fixed wireless access (FWA);
responsive to the SST being for a FWA, executing a procedure based on the network slice subnet related requirements;
completing an allocation procedure to complete a network slice subnet instance allocation; and
transmitting an allocate NSSI response to a network slice subnet management service consumer (NSSMS_consumer).

10. The method of claim 9 wherein executing the procedure comprises provisioning only cells that were identified by a network slice instance allocation procedure.

11. The method of claim 10 wherein the cells that were identified comprises cells in a cell identifier list (CellIDList).

12. The method of claim 9, wherein the network node is configured to perform operations of a network slice subnet management service provider.

13. The method of claim 9, wherein receiving the request for the NSSI allocation comprises receiving the request for the NSSI allocation from an NSSMS_consumer.

14. A network node comprising:
processing circuitry; and
memory coupled with the processing circuitry, wherein the memory includes instructions that when executed by the processing circuitry causes the network node to:
receiving a request for a network slice instance (NSI) allocation, the request having network slice related requirements;
determining whether to create a new NSI or use an existing NSI;
responsive to determining to create a new network slice instance, derive network slice subnet related requirements based on the network slice related requirements, wherein the network node derives the network slice subnet related requirements by determining a type of a slice service type (SST) the request is for;
responsive to the type of the slice being a SST for fixed wireless access (FWA), obtain a cell identifier list (CellIDList) of cells where the NSSI is to be created;
allocate a network slice subnet instance (NSSI) procedure based on the CellIDList;
associate the NSSI with the NSI; and
transmit an allocate NSI response to a network slice management service consumer, (NSMS_consumer).

15. (canceled)

17. (canceled)

18. The network node of claim 14 wherein the network node is configured to obtain the CellIDList by:
searching for a subArea attribute; and
converting the subArea attribute into the CellIDList where the network slice instance is to be created.

19. The network node of claim 14, wherein the network node is configured determine the type of slice based on an SST value.

20. The network node of claim 19, wherein the network node is configured determine the type of slice based on the SST value by determining the type of slice is a fixed wireless access slice based on the SST value being a service type value allocated to the fixed wireless access slice/service type.

21. A network node comprising:
processing circuitry; and
memory coupled with the processing circuitry, wherein the memory includes instructions that when executed by the processing circuitry causes the network node to:
receive a request for a network slice instance (NSI) allocation, the request having network slice related requirements;
determining whether to create a new NSI or use an existing NSI;
responsive to determining to create a new network slice instance, derive network slice subnet related requirements based on the network slice related requirements, wherein the network node derives the network slice subnet related requirements by determining a type of a slice service type (SST) the request is for;
responsive to the type of the slice being a SST for fixed wireless access (FWA), obtain a cell identifier list (CellIDList) of cells where the NSSI is to be created;
allocate a network slice subnet instance (NSSI) procedure based on the CellIDList;
associate the NSSI with the NSI; and
transmit an allocate NSI response to a network slice management service consumer (NSMS_consumer).

22. The network node of claim 21 wherein the network node is configured to execute the procedure by provisioning only cells that were identified by a network slice instance allocation procedure.

23. The network node of claim 21, wherein the network node is configured to receive the request for the NSSI allocation by receiving the request for the NSSI allocation from an NSSMS_consumer.
